(19) United States
(12) Patent Application Publication
(10) Pub. No.: US 2020/0224050 A1
(43) Pub. Date: Jul. 16, 2020

(54) INKJET INK COMPOSITIONS

(71) Applicant: Hewlett-Packard Development Company, L.P., Spring, TX (US)

(72) Inventors: Natalie Harvey, Corvallis, OR (US); Thomas W. Butler, Corvallis, OR (US); Vladimir Jakubek, Corvallis, OR (US)

(21) Appl. No.: 16/648,485

(22) PCT Filed: Nov. 30, 2017
(86) PCT No.: PCT/US2017/063928

§ 371 Date: Mar. 18, 2020

(51) Int. Cl. C09D 11/38; C08G 18/44; C08G 18/28; C08G 18/32; C08G 18/34; C08G 18/38; C08G 18/62; C08G 18/73; C08G 18/75; C08G 18/76; C08G 18/79; C09D 11/102; C09D 11/324; C09D 11/033

(52) U.S. Cl. CPC C09D 11/38; C08K 5/09; C08G 18/2865; C08G 18/3231; C08G 18/3234; C08G 18/3246; C08G 18/3237; C08G 18/325; C08G 18/3275; C08G 18/346; C08G 18/348; C08G 18/3857; C08G 18/6216; C08G 18/73; C08G 18/755; C08G 18/758; C08G 18/765; C08G 18/7671; C08G 18/7685; C08G 18/798; C09D 11/102; C09D 11/324; C09D 11/033; C08K 2201/014; C08G 18/44

(57) ABSTRACT

An example inkjet ink composition includes a colorant, an acid, lithium, an organic solvent package, at least 50 wt % water with respect to the weight of the inkjet ink composition, and from about 0.25 wt % to about 2 wt %, with respect to the weight of the inkjet ink composition, of a polyurethane binder. The acid is selected from the group consisting of oleic acid, linoleic acid, undecanoic acid, dodecanoic acid, tridecanoic acid, and combinations thereof. The organic solvent package includes from about 1 wt % to about 12 wt %, with respect to the weight of the inkjet ink composition, of a first solvent having 1 or 2 free hydroxyl groups and 0 to 3 glycol units and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for improving decap performance of an inkjet ink composition and for improving durability of prints created with an example of the inkjet ink composition disclosed herein;

FIG. 2 is a flow diagram illustrating an example of a method for improving decap performance of an inkjet ink composition and for improving durability of prints created with another example of the inkjet ink composition disclosed herein;

FIG. 3 is an enlarged, cutaway, cross sectional, perspective semi-schematic illustration of an example of a print cartridge including an example of the inkjet ink composition disclosed herein; and

FIGS. 4A and 4B depict decap assessment plots for two examples of the inkjet ink composition disclosed herein.

### DETAILED DESCRIPTION

Examples of the inkjet ink compositions disclosed herein exhibit desirable durability performance and desirable print reliability performance (e.g., desirable decap performance). With many inkjet inks, it is difficult to simultaneously achieve both of these attributes. For example, ink components that are included to improve durability performance may interact with ink components that are included to improve print reliability performance. This interaction may result in diminished durability performance (as compared to a comparable ink including the durability performance-enhancing components and excluding the print reliability performance-enhancing components) or diminished print reliability performance (as compared to a comparable ink including the print reliability performance-enhancing components and excluding the durability performance-enhancing components). For another example, inks having a relatively high solids content (e.g., polymer/binder loading) for improved durability performance may exhibit poor print reliability performance. For still another example, inks having a lower solids content for improved print reliability performance may result in images with poor durability performance.

Durability performance may be measured in terms of the smear resistance of a printed image. The term “smear resistance,” as referred to herein means the ability of a printed image to remain un-smeared when subjected to a two-pass highlighter smear test. In a two-pass highlighter smear test, a highlighter is passed twice across the printed image (e.g., text) and an area adjacent to the printed image (which does not have a printed image thereon), and then, the optical density of the adjacent area is measured to determine how much, if any, of ink from the printed image was transferred to the adjacent area. High smear resistance can lead to good durability performance.

Print reliability performance can be measured in terms of decap performance. The term “decap performance,” as referred to herein, means the ability of the inkjet ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. The length of time a thermal inkjet pen can remain unused and uncapped before spitting would be required to form an acceptable quality ink drop is called decap time, or first drop decap time. A decreased decap time can lead to poor print reliability performance.

Examples of the inkjet ink composition disclosed herein achieve desirable durability performance through a combination of specific organic solvent packages and from about 0.25 wt % to about 2 wt % (with respect to the weight of the inkjet ink composition) of a specific polyurethane binder having a specific molecular weight, and achieve desirable decap performance through a combination of lithium and a particular acid. Including the combination of lithium and the acid has deleteriously affected the durability performance of comparable inks including other polyurethanes. However, it has been unexpectedly discovered that including the combination of lithium and the acid in the inkjet ink compositions disclosed herein does not deleteriously affect the durability performance. Further, examples of solvents (e.g., ethoxylated solvents) that may be included in the organic solvent package are known to coordinate lithium, and thus, it would be expected that including examples of the organic solvent package in examples of the inkjet ink composition would deleteriously affect the decap performance. However, it has been unexpectedly discovered that including the examples of the organic solvent package in the examples of the inkjet ink composition disclosed herein does not deleteriously affect the decap performance.

It has also been unexpectedly discovered that the amount of the polyurethane may be reduced to an amount ranging from about 0.25 wt % to about 2 wt % without significantly affecting durability performance. Reducing the amount of the polyurethane in the inkjet ink compositions may improve its print stability performance by reducing the total solids content of the inkjet ink compositions (which may reduce clogging, plugging, etc. of printer nozzles).

Still further, it has also been unexpectedly discovered that the number average molecular weight of the polyurethane can be increased (to at least 10,000) with chain extenders to improve durability performance without resulting in print performance degradation caused by the polyurethane. In some instances, the use of a chain extender can lead to runaway reactions, and in such instances, the resulting polyurethane may degrade the performance of the ink to the point that the ink is not printable. However, it has been found that the ink disclosed herein, which includes the specific polyurethane of the specific molecular weight, exhibits desirable print performance and generates desirable prints.

In addition, the ink compositions disclosed herein may be suitable for use with any inkjet printing system. For example, the ink compositions may be printed with a thermal inkjet printer having a drop frequency ranging from about 2 kHz to about 18 kHz. For another example, the ink composition may be printed with a high speed inkjet printer having a drop frequency ranging from about 24 kHz to about 36 kHz.

Inkjet Ink Composition with Polyurethane of Formula I

In some examples, the inkjet ink composition comprises: a colorant; an acid selected from the group consisting of oleic acid, linoleic acid, undecanoic acid, dodecanoic acid, tridecanoic acid, and combinations thereof; lithium; an organic solvent package, including: from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; at least 50 wt % water with respect to the weight of the inkjet ink composition; and from about 0.25 wt % to about 2 wt %, with respect to the weight of the inkjet ink composition, of a polyurethane binder having a general structure of Formula I:

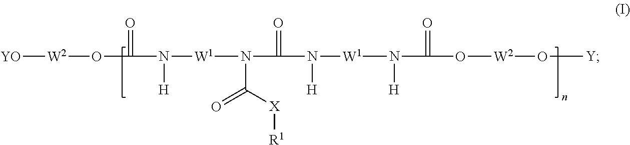

and

for Formula I:
each Y is —(C═O)NHW¹N(C═O)OR² or —(C═O)NH(CH₂)ₘSi(R⁴)₃;
each X is O, S or NR³;
each R¹ is C₁-C₂₀ alkyl, C₆-C₄₀ aryl, polyester, polycarbonate, polyamide or polyurethane, each substituted by one or more hydrophilic groups;
each R² is C₁-C₂₀ alkyl, C₃-C₂₀ substituted alkyl, C₆-C₄₀ aryl or C₉-C₄₀ substituted aryl;
each R³ is H, C₁-C₂₀ alkyl, C₃-C₂₀ substituted alkyl, C₆-C₄₀ aryl or C₉-C₄₀ substituted aryl;
each R⁴ is independently H, C₁-C₂₀ alkyl, C₃-C₂₀ substituted alkyl, C₆-C₄₀ aryl, C₉-C₄₀ substituted aryl or OR⁵;
each R⁵ is independently H, C₁-C₂₀ alkyl or C₆-C₄₀ aryl;
each W¹ is independently C₄-C₂₀ alkyl, C₄-C₂₀ substituted alkyl, C₆-C₂₀ cycloalkyl, C₆-C₂₀ substituted cycloalkyl, C₆-C₄₀ aryl or C₉-C₄₀ substituted aryl;
each W² is C₁-C₂₀ alkyl or C₂-C₂₀ substituted alkyl;
m is an integer from 1 to 15; and
n is an integer from 1 to 200;
   and wherein a chain extender is present between at least some neighboring isocyanates in Formula I such that a number average molecular weight of the polyurethane binder ranges from about 10,000 to about 25,000.

The branched polyurethane of Formula I can be prepared by a ring opening reaction of poly-uretdiones. The poly-uretdione may be reacted with a reagent R¹XH (where R¹ and X are as defined), which provides a branched polyurethane product. In an example, R¹XH contains a hydroxyl group. The reaction is typically carried out at temperatures ranging from about 25° C. and about 150° C. A suitable solvent for this reaction is an aprotic solvent, such as acetone, diethyl ether, ethyl acetate, N-methyl pyrrolidone, nitromethane, acetonitrile, pyridine, methylene chloride, benzene, hexane and tetraglyme (i.e., tetraethylene glycol dimethyl ether).

In an example, the poly-uretdione is an alternating uretdione-carbamate adduct that contains an isocyanate and a diol. Suitable diisocyanates, which may be may be selected from the group consisting of 1,6-hexamethylene diisocyanate (HDI), isophorone diisocyanate (IPDI), trimethylhexamethylene diisocyanate (TMDI), 2,4-toluene diisocyanate (2,4-TDI), 2,6-toluene diisocyanate (2,6-TDI), 4,4′-diphenylmethane diisocyanate (MDI), 4,4-dicyclohexylmethane diisocyanate (H₁₂MDI), 3,3′-dimethyl-4,4′-biphenyl diisocyanate (TODD, dodecane diisocyanate (C₁₂DI), 1,5-naphthalene diisocyanate (NDI), m-tetramethylene xylylene diisocyanate (TMXDI), 1,4-benzene diisocyanate, trans-cyclohexane-1,4-diisocyanate, and 4,6-xylyene diisocyanate.

In some examples, the poly-uretdione may be reacted with a diol-diacid adduct and a polycarbonate diol. The diol-diacid adduct may be formed from biphenyl dianhydride, a sulfolane solvent, and a polycarbonate diol, or from 1,2,4,5 tetracarboxyl benzene dianhydride (pyromellitic dianhydride, or PMDA), a sulfolane solvent, and tetraethylene glycol. In other examples, the poly-uretdione may be reacted with PMDA. Any of these reactions may take place in the solvents noted above, and may the reaction mixture may also include metal complex used in uretdione crosslinked powder coatings.

In an example, the chain extender is a primary monoamino compound, a secondary monoamino compound, a primary diamino compound, a secondary diamino compound, or combinations thereof. In another example, the chain extender is a triamino compound or a tetraamino compound. In an example, the chain extender is a mixture of primary and/or secondary monoamino compound and a primary and/or secondary diamino compound, where at least one of the components carries sulfonic acid and/or carboxyl groups.

Examples of the monoamino compounds include aliphatic and/or alicyclic primary and/or secondary monoamines (such as ethylamine, diethylamine, the isomeric propyl- and butyl-amines), higher linear-aliphatic monoamines and cycloaliphatic monoamines (such as cyclohexylamine). Further examples of the monoamino compounds are amino alcohols, i.e., compounds that contain amino and hydroxyl groups in a molecule, such as, for example, ethanolamine, N-methylethanolamine, diethanolamine and 2-propanolamine. Further examples of the monoamino compounds are those monoamino compounds that additionally carry sulfonic acid and/or carboxyl groups, such as, for example, taurine, glycine or alanine. Some specific examples of the monoamino compounds include diethylamine, ethanolamine or diethanolamine.

Examples of the diamino compounds include 1,2-ethanediamine (i.e., ethylene diamine), propylene diamine, butylene diamine, cyclohexylene diamine, 2-methyl piperazine, phenylene diamine, toluene diamine, xylylene diamine, m-xylene diamine, isophorone diamine, 1,6-hexamethylenediamine, 1-amino-3,3,5-trimethyl-5-aminomethyl-cyclohexane (isophoronediamine), 3,3-dinitrobenzidine, 4,4′-diaminodiphenyl methane, piperazine, and 1,4-diaminocyclohexane or bis-(4-aminocyclohexyl)-methane. Other suitable examples include adipic acid dihydrazide, hydrazine, or hydrazine hydrate. Still other suitable examples include acetone azine, substituted hydrazines such as, for example, dimethyl hydrazine, 1,6-hexamethylene-bis-hydrazine, carbodihydrazine, dihydrazides of dicarboxylic acids and sulphonic acids such as oxalic acid dihydrazide, isophthalic acid dihydrazide, hydrazides made by reacting lactones with hydrazine such as gamma hydroxylbutyric hydrazide, bis-semi-carbazide, and bis-hydrazide carbonic esters of glycols. Still other examples of the diamino compounds include amino alcohols, i.e., compounds that contain amino and hydroxyl groups in a molecule, such as, for example, 1,3-diamino-2-propanol, N-(2-hydroxyethyl)-ethylenediamine or N,N-bis(2-hydroxyethyl)-ethylenediamine. Yet further examples of the diamino compounds are those diamino compounds that additionally carry sulfonate and/or carboxylate groups, such as, for example, the sodium or potassium salts of N-(2-aminoethyl)-2-aminoethanesulfonic acid, of N-(3-aminopropyl)-2-aminoethanesulfonic acid, of N-(3-aminopropyl)-3-aminopropanesulfonic acid, of N-(2-aminoethyl)-3-aminopropanesulfonic acid or of the analogous carboxylic acids. Some specific examples of the diamino compounds Include 1,2-ethanediamine, 1,6-hexamethylenediamine, 1-amino-3,3,5-trimethyl-5-aminomethyl-cyclohexane (isophoronediamine), piperazine, N-(2-hydroxyethyl)-ethylenediamine, N,N-bis(2-hydroxyethyl)-ethylenediamine, the sodium salt of N-(2-aminoethyl)-2-aminoethanesulfonic acid or the sodium salt of N-(2-aminoethyl)-2-aminoethanecarboxylic acid.

It is to be understood that polyamines, such as diethylenetriamine, can also be used instead of a diamino compound.

Examples of suitable triamines include diethylene triamine, tris (2-aminoethyl) amine, and adducts of diethylene triamine with acrylate or its hydrolyzed products, and an example of a suitable tetraamine is triethylene tetramine.

The chain extender may be added during the formation of the polyurethane (i.e., for Formula I, during the ring opening of the polyuretdione). The total amount of chain extender that is added depends upon the desired molecular weight of the polyurethane. In some examples, the number average (M_{N}) molecular weight of the polyurethane binder ranges from about 10,000 to about 25,000. In other examples, the number average (M_{N}) molecular weight of the polyurethane binder ranges from about 12,000 to about 25,000. To achieve the desired molecular weight, the total amount of chain-extender material employed may be such that the ratio of active amine functional groups in the chain-extender to NCO groups in the pre-polymer component (e.g., polyuretdione) ranges from 2:1 to 3:1.

Any of the previously mentioned chain-extenders may also be used as a capping agent, and may be added when it is desirable to terminate the polymerization. The amount of the capping agent employed should be approximately equivalent to the unreacted isocyanate groups in the pre-polymer. The ratio of active hydrogens from amine groups in the chain terminator to isocyanate groups in the pre-polymer are in the range from about 1.0:1 to about 1.2:1, or from about 1.0:1.1 to about 1.1:1, or from about 1.0:1.05 to about 1.1:1, on an equivalent basis.

In the final polyurethane copolymer binder, the acid number of the polyurethane copolymer binder ranges from 50 to 100.

In these examples, the inkjet ink composition may include additional components. An example of an additional component that may be included in the inkjet ink composition includes an additive selected from the group consisting of a surfactant, a biocide, a pH adjuster, and combinations thereof.

In other examples, the inkjet ink composition consists of: the colorant; the acid selected from the group consisting of oleic acid, linoleic acid, undecanoic acid, dodecanoic acid, tridecanoic acid, and combinations thereof; lithium; the organic solvent package, including: from about 1 wt % to about 12 wt %, with respect to the weight of the inkjet ink composition, of the first solvent having 1 or 2 free hydroxyl groups and 0 to 3 glycol units; and from about 0.5 wt % to about 25 wt %, with respect to the weight of the inkjet ink composition, of the second solvent selected from the group consisting of 1-(2-hydroxyethyl)-2-pyrrolidinone, 2-pyrrolidone, glycerol, and combinations thereof; at least 50 wt % water with respect to the weight of the inkjet ink composition; and from about 0.25 wt % to about 2 wt %, with respect to the weight of the inkjet ink composition, of the polyurethane binder having the general structure of Formula I. In these examples, the inkjet ink composition includes no other components.

In still other examples, the inkjet ink composition consists of: the colorant; the acid selected from the group consisting of oleic acid, linoleic acid, undecanoic acid, dodecanoic acid, tridecanoic acid, and combinations thereof; lithium; the organic solvent package, including: from about 1 wt % to about 12 wt %, with respect to the weight of the inkjet ink composition, of the first solvent having 1 or 2 free hydroxyl groups and 0 to 3 glycol units; and from about 0.5 wt % to about 25 wt %, with respect to the weight of the inkjet ink composition, of the second solvent selected from the group consisting of 1-(2-hydroxyethyl)-2-pyrrolidinone, 2-pyrrolidone, glycerol, and combinations thereof; at least 50 wt % water with respect to the weight of the inkjet ink composition; from about 0.25 wt % to about 2 wt %, with respect to the weight of the inkjet ink composition, of the polyurethane binder having the general structure of Formula I; and the additive selected from the group consisting of the surfactant, the biocide, the pH adjuster, and combinations thereof. In these examples, the inkjet ink composition includes no other components.

As mentioned above, desirable durability performance may be achieved through the combination of the organic solvent package and from about 0.25 wt % to about 2 wt % (with respect to the weight of the inkjet ink composition) of the polyurethane binder.

In this example of the inkjet ink composition, the organic solvent package includes from about 1 wt % to about 12 wt %, with respect to the weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof. In an example of the inkjet ink composition, the organic solvent package consists of the first solvent and the second solvent.

In some examples, the first solvent has 1 or 2 free hydroxyl groups and 0 to 3 glycol units. It is to be understood that the first solvent may include multiple solvents as long as each solvent included in the combination has 1 or 2 free hydroxyl groups and 0 to 3 glycol units. In an example, the first solvent having 1 or 2 free hydroxyl groups and 0 to 3 glycol units is selected from the group consisting of tripropylene glycol, tripropylene glycol methyl ether, tripropylene glycol monobutyl ether, tripropylene glycol monoethyl ether, triethylene glycol, triethylene glycol monobutyl ether, triethylene glycol monomethyl ether, diethylene glycol, diethylene glycol butyl ether, ethylene glycol, ethylene glycol butyl ether, ethylene glycol phenyl ether, 3-methyl-1,3-butanediol, 2-ethyl-2-hydroxymethyl-1,3,-propanediol, 2-methyl-2,4-pentanediol, 3-methyl-1,5-pentanediol, 2-ethyl-1,3-hexanediol, and a combination thereof. In another example, the first solvent is selected from the group consisting of tripropylene glycol methyl ether, tripropylene glycol monobutyl ether, tripropylene glycol monoethyl ether, triethylene glycol monomethyl ether, ethylene glycol phenyl ether, 3-methyl-1,3-butanediol, 2-ethyl-2-hydroxymethyl-1,3,-propanediol, 2-methyl-2,4-pentanediol, 3-methyl-1,5-pentanediol, 2-ethyl-1,3-hexanediol, and a combination thereof.

In other examples, the first solvent may have 1 or 2 free hydroxyl groups and 1 to 3 glycol units. In another example, the first solvent has 1 or 2 free hydroxyl groups and 1 to 3 glycol units and is selected from the group consisting of tripropylene glycol, tripropylene glycol methyl ether, tripropylene glycol monobutyl ether, tripropylene glycol monoethyl ether, triethylene glycol, triethylene glycol monobutyl ether, triethylene glycol monomethyl ether, diethylene glycol, diethylene glycol butyl ether, ethylene glycol, ethylene glycol butyl ether, ethylene glycol phenyl ether, and a combination thereof.

The first solvent is present in this example of the ink composition in an amount ranging from about 1 wt % to about 12 wt %, with respect to the weight of the inkjet ink composition. In an example, the first solvent is present in the ink composition in an amount ranging from about 1 wt % to about 8 wt %, with respect to the weight of the inkjet ink composition. In another example, the first solvent is present in the ink composition in an amount ranging from about 2.5 wt % to about 6.5 wt %, with respect to the weight of the inkjet ink composition. In still another example, the first solvent is present in the ink composition in an amount of about 5 wt %.

The second solvent is selected from the group consisting of 1-(2-hydroxyethyl)-2-pyrrolidinone, 2-pyrrolidone, glycerol, and combinations thereof. In an example, the second solvent is 1-(2-hydroxyethyl)-2-pyrrolidinone.

The second solvent is present in this example of the ink composition in an amount ranging from about 0.5 wt % to about 25 wt %, with respect to the weight of the inkjet ink composition. In an example, the second solvent is present in the ink composition in an amount of about 19 wt %.

In an example of this inkjet ink composition, the first solvent is present in the ink composition in an amount of about 5 wt %, and the second solvent is present in the ink composition in an amount of about 19 wt %. In some examples of this inkjet ink composition: the first solvent is 2-ethyl-1,3-hexanediol present in an amount of about 5 wt % and the second solvent is 1-(2-hydroxyethyl)-2-pyrrolidinone present in an amount of about 19 wt %; or the first solvent is 2-ethyl-1,3-hexanediol present in an amount of about 5 wt % and the second solvent is a combination of 1-(2-hydroxyethyl)-2-pyrrolidinone present in an amount of about 11 wt % and glycerol present in an amount of about 8 wt %; or the first solvent is 2-ethyl-1,3-hexanediol present in an amount of about 5 wt % and the second solvent is a combination of 2-pyrrolidone present in an amount of about 11 wt % and glycerol present in an amount of about 8 wt %; or the first solvent is a combination of 2-ethyl-1,3-hexanediol present in an amount of about 5 wt % and 2-ethyl-2-hydroxymethyl-1,3-propanediol present in an amount of about 4 wt % and the second solvent is 1-(2-hydroxyethyl)-2-pyrrolidinone present in an amount of about 15 wt %; or the first solvent is tripropylene glycol methyl ether present in an amount of about 8 wt % and the second solvent is glycerol present in an amount of about 16 wt %; or the first solvent is 2-methyl-1,3-propanediol present in an amount of about 5 wt % and the second solvent is 1-(2-hydroxyethyl)-2-pyrrolidinone present in an amount of about 19 wt %; or the first solvent is 2-ethyl-2-hydroxymethyl-1,3-propanediol present in an amount of about 5 wt % and the second solvent is a combination of 1-(2-hydroxyethyl)-2-pyrrolidinone present in an amount of about 11 wt % and 2-pyrrolidone present in an amount of about 8 wt %.

The polyurethane binder of Formula I is present in example(s) of the inkjet ink composition in an amount ranging from about 0.25 wt % to about 2 wt %, with respect to the weight of the inkjet ink composition. In an example, the polyurethane binder is present in the inkjet ink composition in an amount ranging from about 0.25 wt % to about 0.85 wt %. In another example, the polyurethane binder is present in the inkjet ink composition in an amount of about 0.85 wt %. In still another example, the polyurethane binder is present in the inkjet ink composition in an amount of about 0.25 wt %.

As mentioned above, the inkjet ink compositions disclosed herein achieve desirable decap performance through a combination of lithium and a particular acid. The acid is selected from the group consisting of oleic acid, linoleic acid, undecanoic acid, dodecanoic acid, tridecanoic acid, and combinations thereof.

The acid has a carboxylate head and a long alkyl tail. It appears that the carboxylate group aids in contributing to good decap; for example, the inclusion of oleyl alcohol in the inkjet ink composition appears to contribute to poor decap performance. In addition, the alkyl tail has one or two cis double bonds (e.g., oleic acid has one cis double bond and linoleic acid has two cis double bonds). It has been discovered that the corresponding fully saturated fatty acids with 14 carbons or more, or those with trans double bonds generally do not provide the same benefit for enhancing decap performance. As such, examples of the inkjet ink composition of the present disclosure exclude acids selected from the group consisting of stearic acid (a fully saturated fatty acid with 18 carbons), elaidic acid (the trans isomer of oleic acid), linolenic acid (three cis double bonds), linear (as opposed to branched) saturated fatty acids having a carbon chain of fewer than 11 carbons, and linear saturated fatty acids having a carbon chain of more than 13 carbons, and combinations thereof.

In an example, the acid is dodecanoic acid (also known as lauric acid). Lauric acid has various benefits (that may be desirable in some instances) over oleic acid. For example, lauric acid is commercially available at greater purity (>99% versus 70%-80% for oleic acid). The lithium salt of lauric acid has a higher solubility than that of oleic acid. Since lauric acid has a lower molecular weight than oleic acid, less lauric acid is needed for the same number of moles. Both acids are derived from natural plant/animal sources and are equally inexpensive. In another example, the acid is a combination of dodecanoic acid (lauric acid) and oleic acid.

In an example of this inkjet ink composition, the acid is present in an amount ranging from about 0.1 wt % to about 1.0 wt %, with respect to the weight of the inkjet ink composition. In another example, the acid is present in the inkjet ink composition in an amount of about 0.29 wt % with respect to the weight of the inkjet ink composition.

It is to be understood that the lithium may be present in the composition as an ion in solution, or as a lithium salt of the acid. As an example, the lithium may be added to the ink composition in the form of a number of its salts, for example, lithium chloride, lithium bromide, lithium iodide, lithium hydroxide, lithium acetate, lithium benzoate, lithium nitrate, or combinations thereof. However, lithium carbonate is generally not desirable; as it appears to degrade decap performance in some instances.

It has been found that the combination of lithium and the acid(s) in the examples of the inkjet ink composition of the present disclosure form an anti-evaporative layer during uncapped non-use at an interface between the air and the inkjet ink composition in an orifice of a nozzle, thereby reducing evaporation of the water from the inkjet ink composition. It is believed that formation of the anti-evaporative layer begins within 2 seconds of uncapped non-use.

Further, other alkali metals, e.g., sodium and potassium, may be present in examples of the ink composition. However, it is to be understood that the lithium aids in forming the anti-evaporative layer; whereas other alkali metals that may be present do not function to aid in formation of the anti-evaporative layer, nor do they hinder formation of the anti-evaporative layer.

In an example of this inkjet ink composition, the lithium is present in an amount ranging from about 50 ppm to about 400 ppm. In another example, the lithium is present in the inkjet ink composition in an amount ranging from about 0.01 wt % to about 0.05 wt %. In still another example, the lithium is present in the inkjet ink composition in an amount of about 0.0226 wt %.

In an example of this inkjet ink composition, the lithium is present in an amount ranging from about 50 ppm to about 400 ppm, and the acid is present in an amount ranging from about 0.1 wt % to about 1.0 wt %, with respect to the weight of the inkjet ink composition

The inkjet ink composition including the polyurethane of Formula I may be any color, such as black, cyan, magenta, yellow, etc. As such, the inkjet ink composition includes a colorant. The colorant may be a self-dispersed pigment, a polymer dispersed pigment, a dye, or a combination thereof.

As used herein, “pigment” may generally include organic or inorganic pigment colorants, magnetic particles, aluminas, silicas, and/or other ceramics, organo-metallics, metallic particulates, or other opaque particles that introduce color to the inkjet ink composition. In an example, the pigment is selected from the group consisting of organic pigment colorants, inorganic pigment colorants, organo-metallics, and metallic particulates. The pigment may be any color, including, as examples, a cyan pigment, a magenta pigment, a yellow pigment, a black pigment, a violet pigment, a green pigment, a brown pigment, an orange pigment, a purple pigment, a white pigment, a metallic pigment (e.g., a gold pigment, a bronze pigment, a silver pigment, or a bronze pigment), a pearlescent pigment, or combinations thereof.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

A suitable metallic pigment includes a metal selected from the group consisting of gold, silver, platinum, nickel, chromium, tin, zinc, indium, titanium, copper, aluminum, and alloys of any of these metals. These metals may be used alone or in combination with two or more metals or metal alloys. Some examples of metallic pigments include STANDART® RO100, STANDART® RO200, and DORADO® gold-bronze pigments (available from Eckart Effect Pigments, Wesel, Germany).

The average particle size of the pigments may range anywhere from about 50 nm to about 200 nm. In an example, the average particle size ranges from about 80 nm to about 150 nm.

As mentioned above, in some examples, the colorant may be a polymer dispersed pigment. When the colorant may be a polymer dispersed pigment, the polymer dispersant may be present in inkjet ink composition in an amount ranging from about 0.1 wt % to about 5 wt % of a total weight of the inkjet ink composition.

In an example, the colorant is an anionically dispersed pigment. In an example, the anionically dispersed pigment is a dispersion including water, the pigment, and an anionic polymer that disperses the pigment (i.e., the anionic polymeric dispersant). In an example, the pigment dispersion may also include, for example, a co-solvent, such as 2-pyrrolidone. The pigment dispersion may be prepared or purchased, and the other components of the inkjet ink composition (e.g., the polyurethane, the acid, lithium, the organic solvent, etc.) may be mixed with the pigment dispersion to form the inkjet ink composition.

In other examples, the colorant may be a self-dispersing pigment. As used herein, the term “self-dispersing pigment” refers to a pigment having water-solubilizing groups on the pigment surface. The self-dispersing pigment can be dispersed in water without the polymer dispersant. In an example, the self-dispersing pigment is obtained by carrying out surface modification treatments, such as an acid/base treatment, a coupling agent treatment, a polymer graft treatment, a plasma treatment, an oxidation/reduction treatment, an ozone and light (e.g., light and ultra-violet radiation) treatment, on a pigment. Examples of the self-dispersion type pigment may include, in addition to the above described surface modified pigment, commercially available self-dispersion pigments such as CAB-O-JET®-200, CAB-O-JET®-300, CAB-O-JET®-400, IJX-157, IJX-253, IJX-266, IJX-273, IJX-444, IJX-55, CAB-O-JET®-250C, CAB-O-JET®-260M, CAB-O-JET®-270Y, CAB-O-JET®-450C, CAB-O-JET®-465M, CAB-O-JET®-470Y, and CAB-O-JET®-480M manufactured by Cabot Corporation, and Microjet Black CWI, and CW-2 manufactured by Orient Chemical Industries Co., Ltd.

Still other examples of the colorant include self-dispersed carbon blacks and polymer dispersed pigments commercially available from E.I. du Pont de Nemours and Co. (Wilmington, Del.) and Sensient Technologies Corporation (Milwaukee, Wis.).

In another example, the colorant is a dye. Examples of dyes include a hydrophilic anionic dye, a direct dye, a cationic dye, a reactive dye, a polymer dye and an oil soluble dye, and a fluorescent dye.

In this example of the inkjet ink composition, the colorant may be present in the inkjet ink composition in an amount ranging from about 0.5 wt % to about 14 wt %, with respect to the weight of the inkjet ink composition. In another example, the colorant is present in an amount ranging from about 0.5 wt % to about 8 wt %, with respect to the weight of the inkjet ink composition. In still another example, the colorant is present in an amount ranging from about 2 wt % to about 7 wt %, with respect to the weight of the inkjet ink composition. In still another example, the colorant is present in an amount ranging from about 3 wt % to about 5 wt %, with respect to the weight of the inkjet ink composition. In yet another example, the colorant is present in an amount ranging of about 4.4 wt %, with respect to the weight of the inkjet ink composition.

As mentioned above, the inkjet ink composition may also include an additive selected from the group consisting of a surfactant, a biocide, a pH adjuster, and combinations thereof.

When the inkjet ink composition includes surfactant(s), the surfactant(s) may be present in an amount ranging from about 0.01 wt % to about 2 wt % (with respect to the weight of the inkjet ink composition). In an example, the surfactant is present in the inkjet ink composition in an amount of about 0.01 wt %, with respect to the weight of the inkjet ink composition. In another example, the surfactant is present in the inkjet ink composition in an amount of about 0.1 wt %, with respect to the weight of the inkjet ink composition. In still another example, the surfactant is present in the inkjet ink composition in an amount of about 1.1 wt %, with respect to the weight of the inkjet ink composition.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the inkjet ink composition may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). In another example, the surfactant may be BYK-3410 (butanedioic acid, 2-sulfo-, 1,4-bis(2-ethylhexyl) ester, sodium salt available form BYK Additives & Instruments). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and SURFADONE™ LP-100 (N-octyl-2-pyrrolidone, a low-foaming, nonionic rapid wetting agent with an HLB of 6, available from Ashland Inc.).

This example of the inkjet ink composition may also include biocide(s). In an example, the total amount of biocide(s) in the inkjet ink composition ranges from about 0.1 wt % to about 0.5 wt % (with respect to the weight of the inkjet ink composition). In another example, the total amount of biocide(s) in the inkjet ink composition is about 0.27 wt % (with respect to the weight of the inkjet ink composition).

Examples of suitable biocides include the NUOSEPT® (Ashland Inc.), UCARCIDE™ or KORDEK™ (Dow Chemical Co.), PROXEL® (Arch Chemicals) series, ACTICIDE® B20 and ACTICIDE® M20 (Thor Chemicals), and combinations thereof.

The inkjet ink composition including the polyurethane of Formula I may have a pH ranging from about 7 to about 10, and pH adjuster(s) may be added to the inkjet ink composition to counteract any slight pH drop that may occur over time. In an example, the total amount of pH adjuster (s) in the inkjet ink composition ranges from greater than 0 wt % to about 0.1 wt % (with respect to the weight of the inkjet ink composition). In another example, the total amount of pH adjuster(s) in the inkjet ink composition is about 0.03 wt % (with respect to the weight of the inkjet ink composition).

Examples of suitable pH adjusters include metal hydroxide bases, such as sodium hydroxide (NaOH), potassium hydroxide (KOH), etc.

The balance of this inkjet ink composition is water. The inkjet ink composition includes at least 50 wt % water, with respect to the weight of the inkjet ink composition. In an example, the inkjet ink composition includes at least 60 wt % water, with respect to the weight of the inkjet ink composition. In another example, the inkjet ink composition includes at least 65 wt % water, with respect to the weight of the inkjet ink composition. In still another example, the inkjet ink composition includes water in an amount ranging from about 50 wt % to about 90 wt %, with respect to the weight of the inkjet ink composition. In an example, the water may be deionized water or purified water.

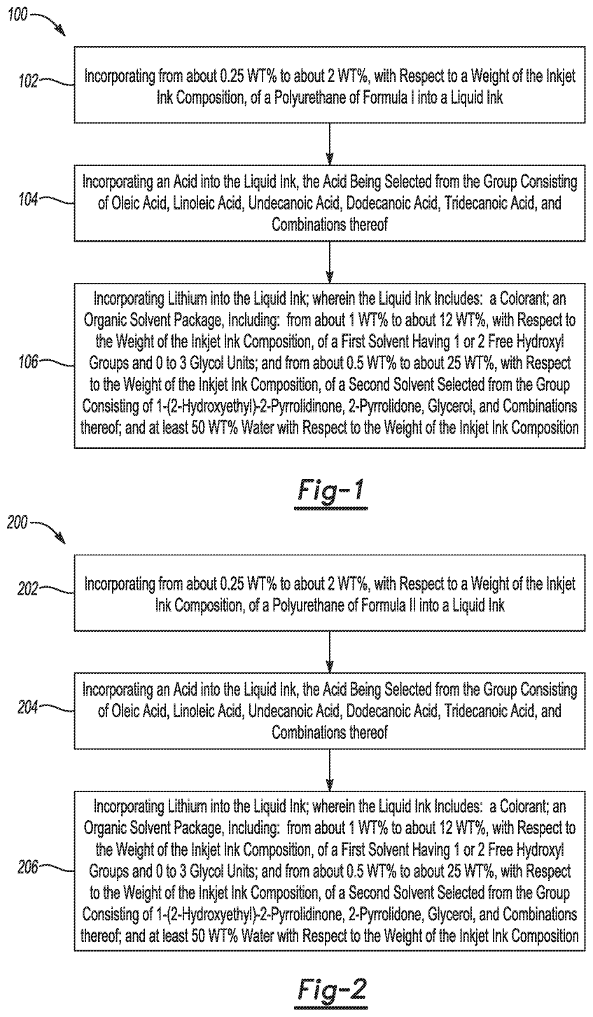

Referring now to FIG. 1, a method 100 for improving decap performance of an example of the inkjet ink composition and for improving durability of prints created with the example of the inkjet ink composition is depicted. One example of the method 100 comprises: incorporating from about 0.25 wt % to about 2 wt %, with respect to a weight of the inkjet ink composition, of the polyurethane of Formula I into a liquid ink (reference numeral 102); incorporating an acid into the liquid ink, the acid being selected from the group consisting of oleic acid, linoleic acid, undecanoic acid, dodecanoic acid, tridecanoic acid, and combinations thereof (reference numeral 104); and incorporating lithium into the liquid ink; wherein the liquid ink includes: a colorant; an organic solvent package, including: from about 1 wt % to about 12 wt %, with respect to the weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; and at least 50 wt % water with respect to the weight of the inkjet ink composition (reference numeral 106).

As shown at reference numeral 102, the method 100 includes incorporating from about 0.25 wt % to about 2 wt %, with respect to the weight of the inkjet ink composition, of the polyurethane of Formula I into the liquid ink. The polyurethane may be as previously described with respect to Formula I. Further, the polyurethane of Formula I may be incorporated into the inkjet ink composition in any of the amounts previously described.

As shown at reference numeral 104, the method 100 includes incorporating the acid into the liquid ink, the acid being selected from the group consisting of oleic acid, linoleic acid, undecanoic acid, dodecanoic acid, tridecanoic acid, and combinations thereof. The acid may be incorporated into the inkjet ink composition in any of the amounts previously described.

As shown at reference numeral 106, the method 100 includes incorporating lithium into the inkjet ink composition. The lithium may be as previously described. Further, the lithium may be incorporated into the inkjet ink composition in any of the amounts previously described.

In one specific example of the method 100, incorporating the acid involves adding from about 0.1 wt % to about 1.0 wt %, with respect to the total weight of the inkjet ink composition, of the acid into the inkjet ink composition; and incorporating the lithium involves adding from about 50 ppm to about 400 ppm of the lithium into the inkjet ink composition.

In this example of the method 100, the liquid ink includes: the colorant; the organic solvent package, including: from about 1 wt % to about 12 wt %, with respect to the weight of the inkjet ink composition, of the first solvent having 1 or 2 free hydroxyl groups and 0 to 3 glycol units; and from about 0.5 wt % to about 25 wt %, with respect to the weight of the inkjet ink composition, of the second solvent selected from the group consisting of 1-(2-hydroxyethyl)-2-pyrrolidinone, 2-pyrrolidone, glycerol, and combinations thereof; and at least 50 wt % water with respect to the weight of the inkjet ink composition. The liquid ink components and there amounts may be as previously described.

Inkjet Ink Composition with Polyurethane of Formula II

In some other examples, the inkjet ink composition comprises: a colorant; an acid selected from the group consisting of oleic acid, linoleic acid, undecanoic acid, dodecanoic acid, tridecanoic acid, and combinations thereof; lithium; an organic solvent package, including from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; at least 50 wt % water with respect to the weight of the inkjet ink composition; and from about 0.25 wt % to about 2 wt %, with respect to the weight of the inkjet ink composition, of a polyurethane binder having a general structure of Formula II:

In another example, the polyurethane binder has a general structure of Formula II:

OCNQ¹ₙQ²ₘQ³ₚR¹—NCO (II),

where the terminal isocyanate groups are capped with a capping agent; and for Formula II:
each Q¹, Q² and Q³ is independently:

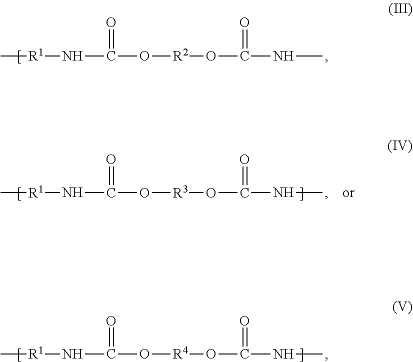

provided that Q¹, Q² and Q³ contain at least one Formula III, one Formula IV and one Formula V groups;

each R¹ is C₁-C₂₀ alkylene, C₃-C₂₀ substituted alkylene, C₃-C₁₀ cycloalkylene, C₃-C₂₀ substituted cycloalkylene, C₆-C₄₀ arylene or C₉-C₄₀ substituted arylene from a diisocyanate;

each R² is independently C₃-C₂₀ substituted alkylene, C₃-C₂₀ substituted cycloalkylene or C₉-C₄₀ substituted arylene;

each R³ is independently C₉-C₂₀ alkylene, C₂ alkylene substituted by C₁-C₁₀ alkyl, C₉-C₂₀ alkylene substituted by C₁-C₁₀ alkyl or C₆-C₁₅ aryl, C₉-C₄₀ arylene, C₉-C₄₀ arylene substituted by C₁-C₁₀ alkyl or C₆-C₂₀ aryl, or —(R⁵—O—R⁶—O—R⁵)—; or HO—R³—OH is a diol incorporating polyether, polyester, polycarbonate, polycarbonate-co-polyester or acrylic;

each R⁴ is independently a C₁-C₇ alkyl, a C₃-C₂₀ alkyl substituted by C₁-C₄₀ alkyl or a C₆-C₁₅ aryl, a C₆-C₄₀ aryl or a C₉-C₄₀ aryl substituted by C₁-C₁₀ alkyl or a C₆-C₁₅ aryl, C₁-C₇ alkylene, C₃-C₂₀ alkylene substituted by C₁-C₁₀ alkyl or C₆-C₁₅ aryl, C₆-C₄₀ arylene, C₉-C₄₀ arylene substituted by C₁-C₁₀ alkyl or C₆-C₂₀ aryl, provided that the backbone atoms on R⁴ forming a chain linking the two oxygen atoms in Formula V are less than 8;

n, m and p are integers from 1 to 200;

the capping agent is R⁷R⁸NH;

each R⁷ is C₁-C₂₀ alkyl;

each Fe is C₁-C₂₀ alkyl;

R⁷ and Fe are taken together with the nitrogen atom to form a cyclic amine or a substituted cyclic amine with an O or S atom replacing a C atom on said cyclic amine;

each R⁶ is independently C₄-C₂₀ alkyl, C₄-C₂₀ alkyl substituted by C₁-C₁₀ alkyl or C₆-C₁₅ aryl, C₉-C₄₀ aryl, C₉-C₄₀ aryl substituted by C₁-C₁₀ alkyl or C₆-C₂₀ aryl;

each R⁵ is independently C₁-C₁₀ alkyl, C₄-C₂₀ alkyl substituted by C₁-C₁₀ alkyl or C₆-C₁₅ aryl; and

q is an integer from 1 to 20;

and wherein a chain extender is present between at least some neighboring isocyanates in Formula II such that a number average molecular weight of the polyurethane binder ranges from about 10,000 to about 25,000.

In the examples disclosed herein, the isocyanate is a diisocyanate. Suitable diisocyanates may be selected from the group consisting of 1,6-hexamethylene diisocyanate (HDI), isophorone diisocyanate (IPDI), trimethylhexamethylene diisocyanate (TMDI), 2,4-toluene diisocyanate (2,4-TDI), 2,6-toluene diisocyanate (2,6-TDI), 4,4′-diphenylmethane diisocyanate (MDI), 4,4-dicyclohexylmethane diisocyanate (H₁₂MDI), 3,3′-dimethyl-4,4′-biphenyl diisocyanate (TODD, dodecane diisocyanate (C₁₂MDI), 1,5-naphthalene diisocyanate (NDI), m-tetramethylene xylylene diisocyanate (TMXDI), 1,4-benzene diisocyanate, trans-cyclohexane-1,4-diisocyanate, and 4,6-xylyene diisocyanate.

Any suitable method that reacts the isocyanate with the compounds of Formulas III, IV, and V, as well as the chain-extender, may be used to form the polyurethane copolymer of Formula II. Different diols may be used to form each of the monomers with Formulas III, IV and V. For example, R², R³, R⁴ groups in Formulas III, IV, and V may come from respective diols.

Some examples of a first diol, which includes a hydrophilic stabilizing group and ultimately forms part of the monomer with Formula (III), include dimethylol acetic acid, 2,2′-dimethylol butanoic acid, 2,2′-dimethylol propionic acid (DMPA), and 2,2′-dimethylol butyric acid.

Some examples of a second diol, which has less than 8 atoms in the backbone chain between two hydroxyl group and ultimately forms part of the monomer with Formula (V), include 1,2-propanediol, 1,3-propanediol, ethylene glycol, 1,4-butanediol, 1,5-pentanediol, 1,6-hexanediol, 1,2-hexanediol, neopentyl glycol, 2-methyl-1,3-propanediol, 3-methyl-1,5-pentane diol, and combinations thereof.

When included, examples of a third diol have a hydrophobic segment and ultimately form part of the monomer with Formula (IV). Some examples of this third diol have the formula OH—R—OH, wherein R is selected from the group consisting of a polyether, a polyester, a polycarbonate, a polycarbonate-co-polyester, and an acrylic. Other examples of the third diol have the formula OH—R⁴—OH. R⁴ may be any of the examples previously given, such as a C₁-C₇ alkyl, or a C₆-C₄₀ aryl, or a C₉-C₄₀ aryl substituted by C₁-C₁₀ alkyl.

Alternatively, a polyol can be used in place of, or in combination with the diols mentioned above. In such cases, these polyols may be triols, such as trimethylol propane or 1,2,6-hexane triol.

Any of the chain extenders previously described for Formula I may be used in this example of the polyurethane binder.

The total amount of chain extender that is added depends upon the desired molecular weight of the polyurethane. In some examples, the number average (M_{N}) molecular weight of the polyurethane binder ranges from about 10,000 to about 25,000. In other examples, the number average (M_{N}) molecular weight of the polyurethane binder ranges from about 12,000 to about 25,000. To achieve the desired molecular weight, the total amount of chain-extender material employed may be such that the ratio of active amine functional groups in the chain-extender to NCO groups in the pre-polymer component ranges from 2:1 to 3:1.

Any of the previously mentioned chain-extenders may also be used as a capping agent, and may be added when it is desirable to terminate the polymerization. The amount of the capping agent employed should be approximately equivalent to the unreacted isocyanate groups in the pre-polymer. The ratio of active hydrogens from amine groups in the chain terminator to isocyanate groups in the pre-polymer are in the range from about 1.0:1 to about 1.2:1, or from about 1.0:1.1 to about 1.1:1, or from about 1.0:1.05 to about 1.1:1, on an equivalent basis.

In the final polyurethane copolymer binder of Formula II, the mole percentage of the second diol is at least 30% of a total mole percentage of diol monomers in the polyurethane copolymer binder. The acid number of the polyurethane copolymer binder ranges from 50 to 100, and the number average (Mₑ) molecular weight of the polyurethane copolymer binder ranges from about 10,000 to about 25,000. In another example, the Mₙ of the polyurethane copolymer binder ranges from about 12,000 to about 25,000 or from about 12,000 to about 20,000.

In these examples, the inkjet ink composition may include additional components. An example of an additional component that may be included in the inkjet ink composition includes an additive selected from the group consisting of a surfactant, a biocide, a pH adjuster, and combinations thereof.

In other examples, the inkjet ink composition consists of: the colorant; the acid selected from the group consisting of oleic acid, linoleic acid, undecanoic acid, dodecanoic acid, tridecanoic acid, and combinations thereof; lithium; the organic solvent package, including: from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; at least 50 wt % water with respect to the weight of the inkjet ink composition; and from about 0.25 wt % to about 2 wt %, with respect to the weight of the inkjet ink composition, of the polyurethane binder having the general structure of Formula II. In these examples, the inkjet ink composition includes no other components.

In still other examples, the inkjet ink composition consists of: the colorant; the acid selected from the group consisting of oleic acid, linoleic acid, undecanoic acid, dodecanoic acid, tridecanoic acid, and combinations thereof; lithium; the organic solvent package, including: from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; from about 0.25 wt % to about 2 wt %, with respect to the weight of the inkjet ink composition, of the polyurethane binder having the general structure of Formula II; and the additive selected from the group consisting of the surfactant, the biocide, the pH adjuster, and combinations thereof. In these examples, the inkjet ink composition includes no other components.

As mentioned above, desirable durability performance may be achieved through the combination of the organic solvent package and from about 0.25 wt % to about 2 wt % (with respect to the weight of the inkjet ink composition) of the polyurethane binder.

In this example of the inkjet ink composition, the organic solvent package includes from about 1 wt % to about 12 wt %, with respect to a weight of the inkjet ink composition, of the first solvent having 1 or 2 free hydroxyl groups and 0 to 3 glycol units; and from about 0.5 wt % to about 25 wt %, with respect to the weight of the inkjet ink composition, of the second solvent selected from the group consisting of 1-(2-hydroxyethyl)-2-pyrrolidinone, 2-pyrrolidone, glycerol, and combinations thereof. In an example, a weight ratio of the first solvent to the second solvent ranges from 0.25 to 0.8. In another example of the inkjet ink composition, this organic solvent package consists of the first solvent and the second solvent.

In some examples, the first solvent has 1 or 2 free hydroxyl groups and 0 to 3 glycol units. It is to be understood that the first solvent may include multiple solvents as long as each solvent included in the combination has 1 or 2 free hydroxyl groups and 0 to 3 glycol units. In an example, the first solvent having 1 or 2 free hydroxyl groups and 0 to 3 glycol units is selected from the group consisting of tripropylene glycol, tripropylene glycol methyl ether, tripropylene glycol monobutyl ether, tripropylene glycol monoethyl ether, triethylene glycol, triethylene glycol monobutyl ether, triethylene glycol monomethyl ether, diethylene glycol, diethylene glycol butyl ether, ethylene glycol, ethylene glycol butyl ether, ethylene glycol phenyl ether, 3-methyl-1,3-butanediol, 2-ethyl-2-hydroxymethyl-1,3,-propanediol, 2-methyl-2,4-pentanediol, 3-methyl-1,5-pentanediol, 2-ethyl-1,3-hexanediol, and a combination thereof. In another example, the first solvent is selected from the group consisting of tripropylene glycol methyl ether, tripropylene glycol monobutyl ether, tripropylene glycol monoethyl ether, triethylene glycol monomethyl ether, ethylene glycol phenyl ether, 3-methyl-1,3-butanediol, 2-ethyl-2-hydroxymethyl-1,3,-propanediol, 2-methyl-2,4-pentanediol, 3-methyl-1,5-pentanediol, 2-ethyl-1,3-hexanediol, and a combination thereof.

In other examples, the first solvent may have 1 or 2 free hydroxyl groups and 1 to 3 glycol units. In another example, the first solvent has 1 or 2 free hydroxyl groups and 1 to 3 glycol units and is selected from the group consisting of tripropylene glycol, tripropylene glycol methyl ether, tripropylene glycol monobutyl ether, tripropylene glycol monoethyl ether, triethylene glycol, triethylene glycol monobutyl ether, triethylene glycol monomethyl ether, diethylene glycol, diethylene glycol butyl ether, ethylene glycol, ethylene glycol butyl ether, ethylene glycol phenyl ether, and a combination thereof.

The second solvent is selected from the group consisting of 1-(2-hydroxyethyl)-2-pyrrolidinone, 2-pyrrolidone, glycerol, and combinations thereof. In an example, the second solvent is 1-(2-hydroxyethyl)-2-pyrrolidinone.

As mentioned above, in some examples, the weight ratio of the first solvent to the second solvent in the examples of the inkjet ink composition including the polyurethane of Formula II ranges from 0.25 (1:4) to 0.8 (1:1.25). As specific examples, the weight ratio of total first solvent(s):total second solvent(s) may be 5:19 (0.26), 9:15 (0.6), or 1:2 (0.5). In these examples, the weight percent of each of the first solvent(s) and the second solvent(s) may be any suitable weight percent within this example of the inkjet ink composition, as long the weight ratio of first solvent(s) to second solvent(s) falls within the range presented herein. As an example, the first solvent(s) may be present in this example of the ink composition in an amount ranging from about 5 wt % to about 9 wt %, and the second solvent(s) may be present in this example of the ink composition in an amount ranging from about 15 wt % to about 19 wt %.

In some examples of this inkjet ink composition: the first solvent is 2-ethyl-1,3-hexanediol present in an amount of about 5 wt % and the second solvent is 1-(2-hydroxyethyl)-2-pyrrolidinone present in an amount of about 19 wt % (weight ratio=0.26); or the first solvent is 2-ethyl-1,3-hexanediol present in an amount of about 5 wt % and the second solvent is a combination of 1-(2-hydroxyethyl)-2-pyrrolidinone present in an amount of about 11 wt % and glycerol present in an amount of about 8 wt % (weight ratio=0.26); or the first solvent is 2-ethyl-1,3-hexanediol present in an amount of about 5 wt % and the second solvent is a combination of 2-pyrrolidone present in an amount of about 11 wt % and glycerol present in an amount of about 8 wt % (weight ratio=0.26); or the first solvent is a combination of 2-ethyl-1,3-hexanediol present in an amount of about 5 wt % and 2-ethyl-2-hydroxymethyl-1,3-propanediol present in an amount of about 4 wt % and the second solvent is 1-(2-hydroxyethyl)-2-pyrrolidinone present in an amount of about 15 wt % (weight ratio=0.6); or the first solvent is tripropylene glycol methyl ether present in an amount of about 8 wt % and the second solvent is glycerol present in an amount of about 16 wt % (weight ratio=0.5); or the first solvent is 2-methyl-1,3-propanediol present in an amount of about 5 wt % and the second solvent is 1-(2-hydroxyethyl)-2-pyrrolidinone present in an amount of about 19 wt % (weight ratio=0.26); or the first solvent is 2-ethyl-2-hydroxymethyl-1,3-propanediol present in an amount of about 5 wt % and the second solvent is a combination of 1-(2-hydroxyethyl)-2-pyrrolidinone present in an amount of about 11 wt % and 2-pyrrolidone present in an amount of about 8 wt % (weight ratio=0.26).

The polyurethane binder of Formula II is present in example(s) of the inkjet ink composition in an amount ranging from about 0.25 wt % to about 2 wt %, with respect to the weight of the inkjet ink composition. In an example, this polyurethane binder is present in the inkjet ink composition in an amount ranging from about 0.25 wt % to about 0.85 wt %. In another example, this polyurethane binder is present in the inkjet ink composition in an amount of about 0.85 wt %. In still another example, this polyurethane binder is present in the inkjet ink composition in an amount of about 0.25 wt %.

As mentioned above, the inkjet ink compositions disclosed herein achieve desirable decap performance through a combination of lithium and a particular acid. Also as mentioned above, it has been found that the combination of lithium and the acid(s) in the examples of the inkjet ink composition of the present disclosure form an anti-evaporative layer during uncapped non-use at an interface between the air and the inkjet ink composition in an orifice of a nozzle, thereby reducing evaporation of the water from the inkjet ink composition. It is believed that formation of the anti-evaporative layer begins within 2 seconds of uncapped non-use. Other alkali metals, e.g., sodium and potassium, may be present in these examples of the ink composition. As mentioned above, it is to be understood that the lithium aids in forming the anti-evaporative layer; whereas other alkali metals that may be present do not function to aid in formation of the anti-evaporative layer, nor do they hinder formation of the anti-evaporative layer.

The acid in this example of the inkjet ink composition is selected from the group consisting of oleic acid, linoleic acid, undecanoic acid, dodecanoic acid, tridecanoic acid, and combinations thereof, and may be used in any of the amounts disclosed herein for the inkjet ink composition containing the polyurethane of Formula I. The lithium may be present in this composition as an ion in solution, or as a lithium salt of the acid. In this example inkjet ink composition, the lithium may also be used in any of the amounts disclosed herein for the inkjet ink composition containing the polyurethane of Formula I. In one example of this inkjet ink composition, the lithium is present in an amount ranging from about 50 ppm to about 400 ppm, and the acid is present in an amount ranging from about 0.1 wt % to about 1.0 wt %, with respect to the weight of the inkjet ink composition.

The inkjet ink composition including the polyurethane of Formula II may be any color, such as black, cyan, magenta, yellow, etc., and thus includes a colorant. In this example inkjet ink composition, any of the colorants disclosed herein for the inkjet ink composition containing the polyurethane of Formula I may be used in any of the amounts disclosed herein for the inkjet ink composition containing the polyurethane of Formula I.

The inkjet ink composition including the polyurethane of Formula II may also include an additive selected from the group consisting of a surfactant, a biocide, a pH adjuster, and combinations thereof. Any of the example additives may be used in any of the amounts disclosed herein for the inkjet ink composition containing the polyurethane of Formula I.

The inkjet ink composition including the polyurethane of Formula II may have a pH ranging from about 7 to about 10, and pH adjuster(s) may be added to the inkjet ink composition to counteract any slight pH drop that may occur over time. In an example, the total amount of pH adjuster (s) in the inkjet ink composition ranges from greater than 0 wt % to about 0.1 wt % (with respect to the weight of the inkjet ink composition). In another example, the total amount of pH adjuster(s) in the inkjet ink composition is about 0.03 wt % (with respect to the weight of the inkjet ink composition). Examples of suitable pH adjusters include metal hydroxide bases, such as sodium hydroxide (NaOH), potassium hydroxide (KOH), etc.

The balance of this inkjet ink composition is water. The inkjet ink composition includes at least 50 wt % water, with respect to the weight of the inkjet ink composition. In an example, the inkjet ink composition includes water in an amount ranging from about 50 wt % to about 90 wt %, with respect to the weight of the inkjet ink composition. In an example, the water may be deionized water or purified water.

Referring now to FIG. 2, a method 200 for improving decap performance of another example of the inkjet ink composition and for improving durability of prints created with the example of the inkjet ink composition is depicted. One example of the method 200 comprises: incorporating from about 0.25 wt % to about 2 wt %, with respect to a weight of the inkjet ink composition, of the polyurethane of Formula II into a liquid ink (reference numeral 202); incorporating an acid into the liquid ink, the acid being selected from the group consisting of oleic acid, linoleic acid, undecanoic acid, dodecanoic acid, tridecanoic acid, and combinations thereof (reference numeral 204); and incorporating lithium into the liquid ink; wherein the liquid ink includes: a colorant; an organic solvent package, including: from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; and at least 50 wt % water with respect to the weight of the inkjet ink composition (reference numeral 206).

As shown at reference numeral 202, the method 200 includes incorporating from about 0.25 wt % to about 2 wt %, with respect to the weight of the inkjet ink composition, of the polyurethane of Formula II into the liquid ink. The polyurethane may be as previously described with respect to Formula II. Further, the polyurethane of Formula II may be incorporated into the inkjet ink composition in any of the amounts previously described.

As shown at reference numeral 204, the method 200 includes incorporating the acid into the liquid ink, the acid being selected from the group consisting of oleic acid, linoleic acid, undecanoic acid, dodecanoic acid, tridecanoic acid, and combinations thereof. The acid may be incorporated into the inkjet ink composition in any of the amounts previously described.

As shown at reference numeral 206, the method 200 includes incorporating lithium into the inkjet ink composition. The lithium may be as previously described. Further, the lithium may be incorporated into the inkjet ink composition in any of the amounts previously described.

In this example of the method 200, the liquid ink includes: the colorant; the organic solvent package, including: from about 1 wt % to about 12 wt %, with respect to a weight of the inkjet ink composition, of a first solvent having 1 or 2 free hydroxyl groups and 0 to 3 glycol units; and from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; and at least 50 wt % water with respect to the weight of the inkjet ink composition. The liquid ink components and there amounts may be as previously described.

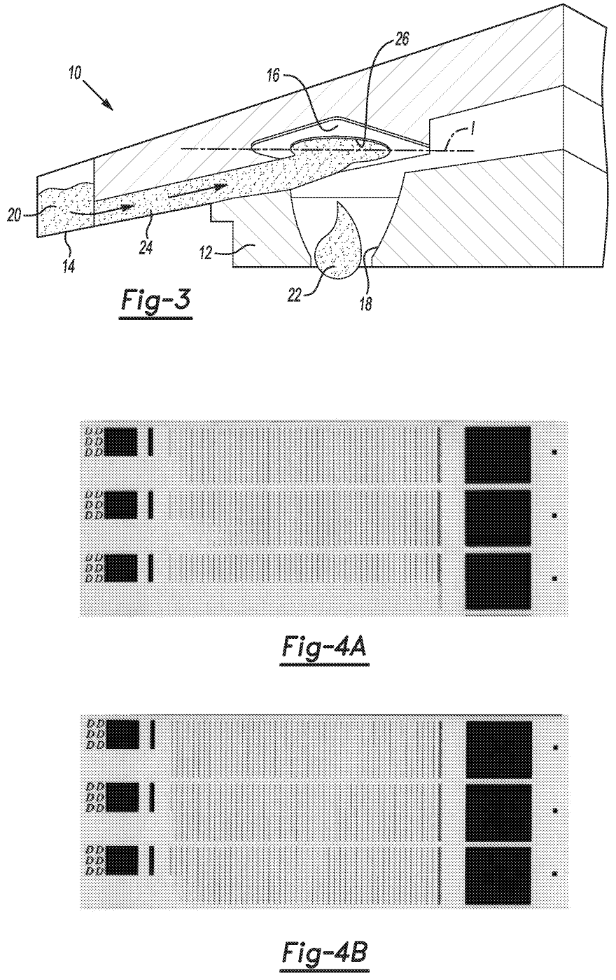

Referring now to FIG. 3, a print cartridge 10 is generally depicted. It is to be understood that the print cartridge 10 may include additional components (some of which are described herein) and that some of the components described herein may be removed and/or modified. Furthermore, components of the print cartridge 10 depicted in FIG. 3 may not be drawn to scale and thus, the print cartridge 10 may have a different size and/or configuration other than as shown therein.

In an example, the print cartridge 10 comprises a fluid reservoir 14; a fluid ejector 16 in fluid communication with the fluid reservoir 14; a nozzle 18 in fluid communication with the fluid ejector 16; an inkjet ink composition 20 present in the fluid reservoir 14; and an anti-evaporative layer present at an interface between air and the inkjet ink composition 20 in an orifice 26 of the nozzle 18, the anti-evaporative layer formed during uncapped non-use, thereby reducing evaporation of the water from the inkjet ink composition 20.

In one example, the inkjet ink composition 20 is the inkjet ink composition disclosed herein that includes the polyurethane of Formula I and its corresponding organic solvent package. In another example, the inkjet ink composition 20 is the inkjet ink composition disclosed herein that includes the polyurethane of Formula II and its corresponding organic solvent package.

The print cartridge 10 includes a housing 12 (which may include one or more layers of different materials) that is operatively connected to the reservoir 14 that contains an example of the inkjet ink composition 20 disclosed herein. A fluid path/ink channel 24 connects the reservoir 14 to a fluid ejector 16. In a thermal inkjet print cartridge, the fluid ejector 16 is a heating element that creates heat to vaporize the inkjet ink composition 20, which creates a bubble that expands to push the inkjet ink composition 20 (in the form of drops 22) out of an orifice 26 of a nozzle 18 that is aligned with the fluid ejector 16. While a single fluid ejector 16 and nozzle 18 is shown, it is to be understood that a single print cartridge 10 may include multiple (e.g., 400 or some other desirable number) fluid ejectors 16 and nozzles 18. While not shown, it is to be understood that the print cartridge 10 includes an integrated circuit that routes signals (e.g., from a processor that is capable of running suitable computer readable instructions) to the desirable fluid ejector(s) 16 and nozzle(s) 18 for firing ink drops 22 therefrom to produce images on a desirable medium.

As mentioned above, the combination of lithium and the acid(s) in the examples of the inkjet ink composition 20 form an anti-evaporative layer during uncapped non-use at an interface I between air and the inkjet ink composition 20 in the orifice 26 of the nozzle 18, thereby reducing evaporation of the water from the inkjet ink composition 20.

To further illustrate the present disclosure, examples are given herein. It is to be understood these examples are provided for illustrative purposes and are not to be construed as limiting the scope of the present disclosure.

### EXAMPLES

### Example 1

Seven examples of the inkjet ink composition were prepared. Each example inkjet ink composition included a self-dispersed carbon black pigment as the colorant, a combination of dodecanoic acid and oleic acid as the acid, lithium as the lithium, 2-ethyl-1,3-hexanediol as the first solvent, 1-(2-hydroxyethyl)-2-pyrrolidone as the second solvent, and a polyurethane with the general structure of Formula II having a number average molecular weight of 11,000. Each example inkjet ink composition had the same general formulation except for the amount of the polyurethane. The amount of the polyurethane in each example inkjet ink composition is shown below in Table 2. The general formulation of the example inkjet ink compositions, except for the amount of the polyurethane, is shown in Table 1, with the wt % of each component that was used.

TABLE 1

| | | Amount |
|---|---|---|
| Ingredient | Specific Component | (wt %) |
| Colorant | Self-dispersed carbon | 4.4 |
| | black pigment | |
| Polyurethane | Formula II | See Table 2 |
| Acid | Dodecanoic acid | 0.26 |
| | Oleic acid | 0.03 |
| Lithium | Lithium | 0.0226 |
| First solvent | 2-ethyl-1,3-hexanediol | 5 |
| Second solvent | 1-(2-hydroxyethyl)-2- | 19 |
| | pyrrolidone | |
| Surfactant | BYK-3410 | 1 |
| | SURFYNOL ® 104 | 0.05 |
| | SURFADONE ® LP100 | 0.05 |
| Biocide | ACTICIDE ® B20 | 0.20 |
| | ACTICIDE ® M20 | 0.07 |
| Deionized Water | | Balance |

Each example inkjet ink composition was tested for durability. Each example inkjet ink composition was used to create a print on HP® Multipurpose paper media with COLORLOK® technology (available from International Paper Company, Tennessee) using an ink flux of 56 ng/300^{th} (printed using a HP® Cartridge 940 in an OFFICEJET® Pro 8000 inkjet printer available from Hewlett-Packard, Co., California). The durability of each print was measured by a two pass highlighter smear test one hour after printing. The two pass highlighter smear test involved passing a yellow highlighter over the print two different times, one right after the other. A Faber-Castell highlighter (available from Faber-Castell Aktiengesellschaft, Germany) was passed over the image at 500 grams weight pressure. The results of the durability measurements in milli-optical density (mOD) are shown below in Table 2, in addition to showing the amount of the polyurethane in each example inkjet ink composition. The optical densities were measured using Gretag Macbeth Spectrolino densitometer.

TABLE 2

| | Amount of | |
|---|---|---|
| | polyurethane | |
| Ink used to | of Formula II | Durability |
| generate the print | (wt %) | (mOD) |
| Example inkjet ink | 1.7 | 26 |
| composition 1 | | |
| Example inkjet ink | 1.5 | 29 |
| composition 2 | | |
| Example inkjet ink | 1.3 | 27 |
| composition 3 | | |
| Example inkjet ink | 1.2 | 33 |
| composition 4 | | |
| Example inkjet ink | 1.1 | 32 |
| composition 5 | | |
| Example inkjet ink | 1 | 31 |
| composition 6 | | |
| Example inkjet ink | 0.85 | 36 |
| composition 7 | | |

As shown in Table 2, the durability measurements are comparable for each of the example inkjet ink compositions. This indicates that the amount of the polyurethane may be reduced (e.g., to 0.85 wt %, from typical amounts greater than 2 wt %) without significantly affecting durability performance. Further, it was unexpectedly discovered that the lithium and the acid in the example inkjet ink compositions did not deleteriously affect the durability performance.

### Example 2

Two additional examples of the inkjet ink composition were prepared. Both of the additional example inkjet ink composition included a self-dispersed carbon black pigment as the colorant, a combination of dodecanoic acid and oleic acid as the acid, lithium as the lithium, and a polyurethane with the general structure of Formula II (M_{N}=11,000). For one of the additional example inkjet ink compositions, 2-methyl-1,3-propanediol was the first solvent, and 1-(2-hydroxyethyl)-2-pyrrolidone was the second solvent. For the other additional example inkjet ink composition, 2-ethyl-2-hydroxymethyl-1,3-propanediol was the first solvent, and a combination of 1-(2-hydroxyethyl)-2-pyrrolidone and 2-pyrrolidone was the second solvent. Both example inkjet ink composition had the same general formulation except for the organic solvent package (i.e., the first and second solvents). The general formulation of the both of the additional example inkjet ink compositions is shown in Table 3, with the wt % of each component that was used.

TABLE 3

| | | Example | Example |
|---|---|---|---|
| | | inkjet ink | inkjet ink |
| | | composition | composition |
| | | 8 | 9 |
| Ingredient | Specific Component | (wt %) | (wt %) |
| Colorant | Self-dispersed carbon | 4.4 | 4.4 |
| | black pigment | | |
| Acid | Dodecanoic acid | 0.26 | 0.26 |
| | Oleic acid | 0.03 | 0.03 |
| Lithium | Lithium | 0.0226 | 0.0226 |
| First solvent | 2-methyl-1,3-propanediol | 5 | 0 |
| | 2-ethyl-2-hydroxymethyl- | 0 | 5 |
| | 1,3-propanediol | | |
| Second solvent | 1-(2-hydroxyethyl)-2- | 19 | 11 |
| | pyrrolidone | | |
| | 2-pyrrolidone | 0 | 8 |
| Polyurethane | Formula II | 1.7 | 1.7 |
| Surfactant | SURFYNOL ® 104 | 0.05 | 0.05 |
| | SURFADONE ™ LP-100 | 0.05 | 0.05 |
| Biocide | ACTICIDE ® B20 | 0.20 | 0.20 |
| | ACTICIDE ® M20 | 0.07 | 0.07 |
| Deionized Water | | Balance | Balance |

Both of the example inkjet ink compositions were tested for durability. Both example inkjet ink compositions were used to create a print on HP® Multipurpose paper media with COLORLOK® technology (available from International Paper Company, Tennessee) using an ink flux of 56 ng/300^{th} (printed using a HP® Cartridge 940 in an OFFICEJET® Pro 8000 inkjet printer available from Hewlett-Packard, Co., California). The durability of each print was measured by a two pass highlighter smear test one hour after printing. A Faber-Castell highlighter (available from Faber-Castell Aktiengesellschaft, Germany) was passed over the image at 500 grams weight pressure. The print created with example inkjet ink composition 8 had a durability in milli-optical density (mOD) of 29 mOD, and the print created with example inkjet ink composition 9 had a durability in milli-optical density (mOD) of 43 mOD. The optical densities were measured using Gretag Macbeth Spectrolino densitometer. The durability measurements for example inkjet ink compositions 8 and 9 are comparable to the example inkjet ink compositions 1-7. This indicates that the organic solvent package may include different examples of the first and second solvent disclosed herein without significantly affecting durability performance. Further, the lithium and the acid in example inkjet ink compositions 8 and 9 did not deleteriously affect the durability performance.

### Example 3

Twelve additional examples of the inkjet ink composition were prepared. Each of the additional example inkjet ink compositions included a self-dispersed carbon black pigment as the colorant, a combination of dodecanoic acid and oleic acid as the acid, lithium as the lithium, a combination of 2-ethyl-1, 3-hexanediol and 2-ethyl-2-hydroxymethyl-1,3-propanediol as the first solvent, 1-(2-hydroxyethyl)-2-pyrrolidone as the second solvent, and a polyurethane with the general structure of Formula II (M_{N}=11,000). Each example inkjet ink composition had the same general formulation except for the amount of the polyurethane. The amount of the polyurethane in each example inkjet ink composition is shown below in Tables 5 and 6. The general formulation of the example inkjet ink compositions, except for the amount of the polyurethane, is shown in Table 4, with the wt % of each component that was used.

TABLE 4

| | | Amount |
|---|---|---|
| Ingredient | Specific Component | (wt %) |
| Colorant | Self-dispersed carbon | 4.4 |
| | black pigment | |
| Polyurethane | Formula II | See Table 5 |
| | | and Table 6 |
| Acid | Dodecanoic acid | 0.26 |
| | Oleic acid | 0.03 |
| Lithium | Lithium | 0.0226 |
| First solvent | 2-ethyl-1,3-hexanediol | 5 |
| | 2-ethyl-2-hydroxymethyl- | 4 |
| | 1,3-propanediol | |
| Second solvent | 1-(2-hydroxyethyl)- | 15 |
| | 2-pyrrolidone | |
| Surfactant | BYK-3410 | 0.1 |
| Biocide | ACTICIDE ® B20 | 0.20 |
| | ACTICIDE ® M20 | 0.07 |
| Water | | Balance |

Each additional example inkjet ink composition was tested for durability. Each additional example inkjet ink composition was used to create a print on HP® Multipurpose paper media with COLORLOK® technology (available from International Paper Company, Tennessee) using an ink flux of 56 ng/300^{th} (printed using a HP® Cartridge 940 in an OFFICEJET® Pro 8000 inkjet printer available from Hewlett-Packard, Co., California). The durability of each print was measured by two pass highlighter smear test one hour after printing. A Faber-Castell highlighter (available from Faber-Castell Aktiengesellschaft, Germany) was passed over the image at 500 grams weight pressure. The results of the durability measurements in milli-optical density (mOD) are shown below in Table 5. The optical densities were measured using Gretag Macbeth Spectrolino densitometer. Also shown in Table 5 is the amount of the polyurethane in each additional example inkjet ink composition.

TABLE 5

| | Amount of | |
|---|---|---|
| | polyurethane | |
| Ink used to | of Formula II | Durability |
| generate the print | (wt %) | (mOD) |
| Example inkjet ink | 2 | 20 |
| composition 10 | | |
| Example inkjet ink | 1.5 | 22 |
| composition 11 | | |
| Example inkjet ink | 1.3 | 23 |
| composition 12 | | |
| Example inkjet ink | 1.1 | 24 |
| composition 13 | | |
| Example inkjet ink | 1 | 26 |
| composition 14 | | |
| Example inkjet ink | 0.85 | 29 |
| composition 15 | | |
| Example inkjet ink | 0.75 | 20 |
| composition 16 | | |
| Example inkjet ink | 0.65 | 19 |
| composition 17 | | |
| Example inkjet ink | 0.55 | 17 |
| composition 18 | | |
| Example inkjet ink | 0.45 | 17 |
| composition 19 | | |
| Example inkjet ink | 0.35 | 23 |
| composition 20 | | |
| Example inkjet ink | 0.25 | 22 |
| composition 21 | | |

As shown in Table 5, the durability measurements are comparable for the example inkjet ink compositions. This indicates that the amount of the polyurethane may be reduced (e.g., to 0.25 wt %) without significantly affecting durability performance. Further, the lithium and the acid in the example inkjet ink compositions did not deleteriously affect the durability performance.

Each additional example inkjet ink composition was also tested for black optical density (KOD). Each additional example inkjet ink composition was used to create a print on HP® Multipurpose paper media with COLORLOK® technology (available from International Paper Company, Tennessee) and a print on Spectrum Standard 92 Multipurpose paper (available from Georgia Pacific, Georgia) using an ink flux of 56 ng/300^{th} (printed using a HP® Cartridge 940 in an OFFICEJET® Pro 8000 inkjet printer available from Hewlett-Packard, Co., California). The black optical density of each print was measured, and the results of the black optical density measurements in milli-optical density (mOD) are shown below in Table 6. The optical densities were measured using Gretag Macbeth Spectrolino densitometer. Also shown in Table 6 is the amount of the polyurethane in each additional example inkjet ink composition.

TABLE 6

| | Amount of | KOD on | KOD on |
|---|---|---|---|
| | polyurethane | ColorLok ® | multipurpose |
| Ink used to | of Formula II | media | paper |
| generate the print | (wt %) | (mOD) | (mOD) |
| Example inkjet ink | 2 | 1.22 | 1.1772 |
| composition 10 | | | |
| Example inkjet ink | 1.5 | 1.24 | 1.183 |
| composition 11 | | | |
| Example inkjet ink | 1.3 | 1.24 | 1.1674 |
| composition 12 | | | |
| Example inkjet ink | 1.1 | 1.25 | 1.1708 |
| composition 13 | | | |
| Example inkjet ink | 1 | 1.26 | 1.162 |
| composition 14 | | | |
| Example inkjet ink | 0.85 | 1.26 | 1.1548 |
| composition 15 | | | |
| Example inkjet ink | 0.75 | 1.26 | 1.1486 |
| composition 16 | | | |
| Example inkjet ink | 0.65 | 1.26 | 1.148 |
| composition 17 | | | |
| Example inkjet ink | 0.55 | 1.26 | 1.14 |
| composition 18 | | | |
| Example inkjet ink | 0.45 | 1.25 | 1.1474 |
| composition 19 | | | |
| Example inkjet ink | 0.35 | 1.25 | 1.1498 |
| composition 20 | | | |
| Example inkjet ink | 0.25 | 1.24 | 1.1474 |
| composition 21 | | | |

As shown in Table 6, the durability measurements are comparable for the example inkjet ink compositions. This indicates that the amount of the polyurethane may be reduced (e.g., to 0.25 wt %) without significantly affecting image quality performance.

Example inkjet ink compositions 10 and 21 were also tested for decap performance. A decap assessment plot was printed for example inkjet ink composition 10 and example inkjet ink composition 21. FIG. 4A shows the decap assessment plot for example inkjet ink composition 10, and FIG. 4B shows the decap assessment plot for example inkjet ink composition 21. FIGS. 4A and 4B demonstrate that the example inkjet ink compositions have good decap performance. Further, it was unexpectedly discovered that the organic solvent package (i.e., the first and second solvents) in the example inkjet ink compositions did not deleteriously affect the decap performance.

It is to be understood that the ranges provided herein include the stated range and any value or sub-range within the stated range. For example, a range from about 1 wt % to about 12 wt % should be interpreted to include not only the explicitly recited limits of from about 1 wt % to about 12 wt %, but also to include individual values, such as 1.01 wt %, 1.8 wt %, 5.0 wt %, 7.05 wt %, 10.785 wt %, etc., and sub-ranges, such as from about 1.1 wt % to about 10.95 wt %, from about 1.5 wt % to about 11.5 wt %, from about 2.5 wt % to about 8.0 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink composition, comprising:
a colorant;
an acid selected from the group consisting of oleic acid, linoleic acid, undecanoic acid, dodecanoic acid, tridecanoic acid, and combinations thereof;
lithium;
an organic solvent package, including:
from about 1 wt % to about 12 wt %, with respect to a weight of the inkjet ink composition, of a first solvent having 1 or 2 free hydroxyl groups and 0 to 3 glycol units; and
from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof;
at least 50 wt % water with respect to the weight of the inkjet ink composition; and
from about 0.25 wt % to about 2 wt %, with respect to the weight of the inkjet ink composition, of a polyurethane binder having a general structure of Formula I: 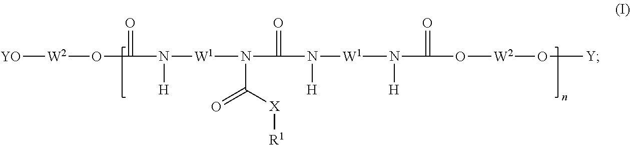
wherein
for Formula I:
each Y is —(C═O)NHW¹N(C═O)OR² or —(C═O)NH(CH₂)ₘSi(R⁴)₃;
each X is O, S or NR³;
each R¹ is C₁-C₂₀ alkyl, C₆-C₄₀ aryl, polyester, polycarbonate, polyamide or polyurethane, each substituted by one or more hydrophilic groups;
each R² is C₁-C₂₀ alkyl, C₃-C₂₀ substituted alkyl, C₆-C₄₀ aryl or C₉-C₄₀ substituted aryl;
each R³ is H, C₁-C₂₀ alkyl, C₃-C₂₀ substituted alkyl, C₆-C₄₀ aryl or C₉-C₄₀ substituted aryl;
each R⁴ is independently H, C₁-C₂₀ alkyl, C₃-C₂₀ substituted alkyl, C₆-C₄₀ aryl, C₉-C₄₀ substituted aryl or OR⁵;
each R⁵ is independently H, C₁-C₂₀ alkyl or C₆-C₄₀ aryl;
each W¹ is independently C₄-C₂₀ alkyl, C₄-C₂₀ substituted alkyl, C₆-C₂₀ cycloalkyl, C₆-C₂₀ substituted cycloalkyl, C₆-C₄₀ aryl or C₉-C₄₀ substituted aryl;
each W² is C₁-C₂₀ alkyl or C₂-C₂₀ substituted alkyl;
m is an integer from 1 to 15; and
n is an integer from 1 to 200;
and wherein a chain extender is present between at least some neighboring isocyanates in Formula I such that a number average molecular weight of the polyurethane binder ranges from about 10,000 to about 25,000.

2. The inkjet ink composition as defined in claim 1 wherein the first solvent having 1 or 2 free hydroxyl groups and 0 to 3 glycol units is selected from the group consisting of tripropylene glycol, tripropylene glycol methyl ether, tripropylene glycol monobutyl ether, tripropylene glycol monoethyl ether, triethylene glycol, triethylene glycol monobutyl ether, triethylene glycol monomethyl ether, diethylene glycol, diethylene glycol butyl ether, ethylene glycol, ethylene glycol butyl ether, ethylene glycol phenyl ether, 3-methyl-1,3-butanediol, 2-ethyl-2-hydroxymethyl-1,3-propanediol, 2-methyl-1,3-propanediol, 2-methyl-2,4-pentanediol, 3-methyl-1,5-pentanediol, 2-ethyl-1,3-hexanediol, and a combination thereof.

3. The inkjet ink composition as defined in claim 1 wherein the chain extender is a primary monoamino compound, a secondary monoamino compound, a primary diamino compound, a secondary diamino compound, or combinations thereof.

4. The inkjet ink composition as defined in claim 1 wherein the number average molecular weight of the polyurethane binder ranges from about 12,000 to about 25,000.

5. The inkjet ink composition as defined in claim 1 wherein:
the lithium is present in an amount ranging from about 50 ppm to about 400 ppm; and
the acid is present in an amount ranging from about 0.1 wt % to about 1.0 wt % with respect to the weight of the inkjet ink composition.

6. The inkjet ink composition as defined in claim 1 wherein the organic solvent package consists of the first solvent and the second solvent.

7. The inkjet ink composition as defined in claim 1 wherein one of:
the first solvent is 2-ethyl-1,3-hexanediol present in an amount of about 5 wt % and the second solvent is 1-(2-hydroxyethyl)-2-pyrrolidinone present in an amount of about 19 wt %; or
the first solvent is 2-ethyl-1,3-hexanediol present in an amount of about 5 wt % and the second solvent is a combination of 1-(2-hydroxyethyl)-2-pyrrolidinone present in an amount of about 11 wt % and glycerol present in an amount of about 8 wt %; or
the first solvent is 2-ethyl-1,3-hexanediol present in an amount of about 5 wt % and the second solvent is a combination of 2-pyrrolidone present in an amount of about 11 wt % and glycerol present in an amount of about 8 wt %; or
the first solvent is a combination of 2-ethyl-1,3-hexanediol present in an amount of about 5 wt % and 2-ethyl-2-hydroxymethyl-1,3-propanediol present in an amount of about 4 wt % and the second solvent is 1-(2-hydroxyethyl)-2-pyrrolidinone present in an amount of about 15 wt %; or
the first solvent is tripropylene glycol methyl ether present in an amount of about 8 wt % and the second solvent is glycerol present in an amount of about 16 wt %; or
the first solvent is 2-methyl-1,3-propanediol present in an amount of about 5 wt % and the second solvent is 1-(2-hydroxyethyl)-2-pyrrolidinone present in an amount of about 19 wt %; or
the first solvent is 2-ethyl-2-hydroxymethyl-1,3-propanediol present in an amount of about 5 wt % and the second solvent is a combination of 1-(2-hydroxyethyl)-2-pyrrolidinone present in an amount of about 11 wt % and 2-pyrrolidone present in an amount of about 8 wt %.

8. An inkjet ink composition, comprising:
a colorant;
an acid selected from the group consisting of oleic acid, linoleic acid, undecanoic acid, dodecanoic acid, tridecanoic acid, and combinations thereof;
lithium;
an organic solvent package, including:
from about 1 wt % to about 12 wt %, with respect to a weight of the inkjet ink composition, of a first solvent having 1 or 2 free hydroxyl groups and 0 to 3 glycol units; and
from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof;
at least 50 wt % water with respect to the weight of the inkjet ink composition; and
from about 0.25 wt % to about 2 wt %, with respect to the weight of the inkjet ink composition, of a polyurethane binder having a general structure of Formula II:
OCNQ¹ₙQ²ₘQ³ₚR¹—NCO (II),
where the terminal isocyanate groups are capped with a capping agent; and
for Formula II:
each Q¹, Q² and Q³ is independently: 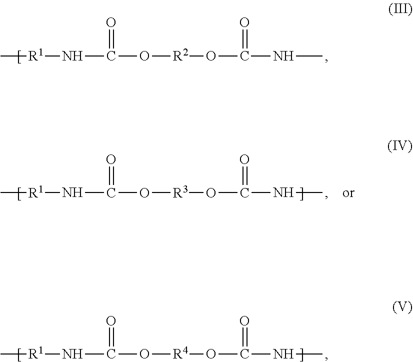
provided that Q¹, Q² and Q³ contain at least one Formula III, one Formula IV and one Formula V groups;
each R¹ is C₁-C₂₀ alkylene, C₃-C₂₀ substituted alkylene, C₃-C₁₀ cycloalkylene, C₃-C₂₀ substituted cycloalkylene, C₆-C₄₀ arylene or C₉-C₄₀ substituted arylene from a diisocyanate;
each R² is independently C₃-C₂₀ substituted alkylene, C₃-C₂₀ substituted cycloalkylene or C₉-C₄₀ substituted arylene;
each R³ is independently C₉-C₂₀ alkylene, C₂ alkylene substituted by C₁-C₁₀ alkyl, C₉-C₂₀ alkylene substituted by C₁-C₁₀ alkyl or C₆-C₁₅ aryl, C₉-C₄₀ arylene, C₉-C₄₀ arylene substituted by C₁-C₁₀ alkyl or C₆-C₂₀ aryl, or —(R⁵—O—R⁶—O—R⁵)—; or HO—R³—OH is a diol incorporating polyether, polyester, polycarbonate, polycarbonate-co-polyester or acrylic;
each R⁴ is independently a C₁-C₇ alkyl, a C₃-C₂₀ alkyl substituted by C₁-C₄₀ alkyl or a C₆-C₁₅ aryl, a C₆-C₄₀ aryl or a C₉-C₄₀ aryl substituted by C₁₀ alkyl or a C₆-C₁₅ aryl, C₁-C₇ alkylene, C₃-C₂₀ alkylene substituted by C₁₀ alkyl or C₆-C₁₅ aryl, C₆-C₄₀ arylene, C₉-C₄₀ arylene substituted by C₁-C₁₀ alkyl or C₆-C₂₀ aryl, provided that the backbone atoms on R⁴ forming a chain linking the two oxygen atoms in Formula V are less than 8;
n, m and p are integers from 1 to 200;
the capping agent is R⁷R⁸NH;
each R⁷ is C₁-C₂₀ alkyl;
each R⁸ is C₁-C₂₀ alkyl;
R⁷ and Fe are taken together with the nitrogen atom to form a cyclic amine or a substituted cyclic amine with an O or S atom replacing a C atom on said cyclic amine;
each R⁶ is independently C₄-C₂₀ alkyl, C₄-C₂₀ alkyl substituted by C₁₀ alkyl or C₆-C₁₅ aryl, C₉-C₄₀ aryl, C₉-C₄₀ aryl substituted by C₁-C₁₀ alkyl or C₆-C₂₀ aryl;
each R⁵ is independently C₁-C₁₀ alkyl, C₄-C₂₀ alkyl substituted by C₁-C₁₀ alkyl or C₆-C₁₅ aryl; and
q is an integer from 1 to 20;
and wherein a chain extender is present between at least some neighboring isocyanates in Formula II such that a number average molecular weight of the polyurethane binder ranges from about 10,000 to about 25,000.

9. The inkjet ink composition as defined in claim 8 wherein the chain extender is a primary monoamino compound, a secondary monoamino compound, a primary diamino compound, a secondary diamino compound, or combinations thereof.

10. The inkjet ink composition as defined in claim 8 wherein a weight ratio of the first solvent to the second solvent ranges from 0.25 to 0.8.

11. The inkjet ink composition as defined in claim 8 wherein:
the lithium is present in an amount ranging from about 50 ppm to about 400 ppm; and
the acid is present in an amount ranging from about 0.1 wt % to about 1.0 wt % with respect to the weight of the inkjet ink composition.

12. The inkjet ink composition as defined in claim 8 wherein the number average molecular weight of the polyurethane binder ranges from about 12,000 to about 25,000.

13. The inkjet ink composition as defined in claim 8 wherein one of:
the first solvent is 2-ethyl-1,3-hexanediol present in an amount of about 5 wt % and the second solvent is 1-(2-hydroxyethyl)-2-pyrrolidinone present in an amount of about 19 wt %; or
the first solvent is 2-ethyl-1,3-hexanediol present in an amount of about 5 wt % and the second solvent is a combination of 1-(2-hydroxyethyl)-2-pyrrolidinone present in an amount of about 11 wt % and glycerol present in an amount of about 8 wt %; or
the first solvent is 2-ethyl-1,3-hexanediol present in an amount of about 5 wt % and the second solvent is a combination of 2-pyrrolidone present in an amount of about 11 wt % and glycerol present in an amount of about 8 wt %; or
the first solvent is a combination of 2-ethyl-1,3-hexanediol present in an amount of about 5 wt % and 2-ethyl-2-hydroxymethyl-1,3-propanediol present in an amount of about 4 wt % and the second solvent is 1-(2-hydroxyethyl)-2-pyrrolidinone present in an amount of about 15 wt %; or
the first solvent is tripropylene glycol methyl ether present in an amount of about 8 wt % and the second solvent is glycerol present in an amount of about 16 wt %; or
the first solvent is 2-ethyl-2-hydroxymethyl-1,3-propanediol present in an amount of about 5 wt % and the second solvent is a combination of 1-(2-hydroxyethyl)-2-pyrrolidinone present in an amount of about 11 wt % and 2-pyrrolidone present in an amount of about 8 wt %; or
the first solvent is 2-methyl-1,3-propanediol present in an amount of about 5 wt %, and the second solvent is 1-(2-hydroxyethyl)-2-pyrrolidinone present in an amount of about 19 wt %.

14. A method for improving decap performance of an inkjet ink composition and for improving durability of prints created with the inkjet ink composition, the method comprising:
incorporating from about 0.25 wt % to about 2 wt %, with respect to a weight of the inkjet ink composition, of a polyurethane into a liquid ink, the polyurethane having a general structure of Formula I: 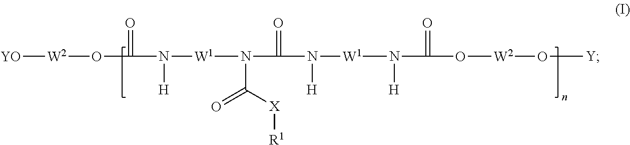
and
for Formula I:
each Y is —(C═O)NHW¹N(C═O)OR² or —(C═O)NH(CH₂)ₘSi(R⁴)₃;
each X is O, S or NR³;
each R¹ is C₁-C₂₀ alkyl, C₆-C₄₀ aryl, polyester, polycarbonate, polyamide or polyurethane, each substituted by one or more hydrophilic groups;
each R² is C₁-C₂₀ alkyl, C₃-C₂₀ substituted alkyl, C₆-C₄₀ aryl or C₉-C₄₀ substituted aryl;
each R³ is H, C₁-C₂₀ alkyl, C₃-C₂₀ substituted alkyl, C₆-C₄₀ aryl or C₉-C₄₀ substituted aryl;
each R⁴ is independently H, C₁-C₂₀ alkyl, C₃-C₂₀ substituted alkyl, C₆-C₄₀ aryl, C₉-C₄₀ substituted aryl or OR⁵;
each R⁵ is independently H, C₁-C₂₀ alkyl or C₆-C₄₀ aryl;
each W¹ is independently C₄-C₂₀ alkyl, C₄-C₂₀ substituted alkyl, C₆-C₂₀ cycloalkyl, C₆-C₂₀ substituted cycloalkyl, C₆-C₄₀ aryl or C₉-C₄₀ substituted aryl;
each W² is C₁-C₂₀ alkyl or C₂-C₂₀ substituted alkyl;
m is an integer from 1 to 15; and
n is an integer from 1 to 200;
and wherein a chain extender is present between at least some neighboring isocyanates in Formula I such that a number average molecular weight of the polyurethane binder ranges from about 10,000 to about 25,000;
incorporating an acid into the liquid ink, the acid being selected from the group consisting of oleic acid, linoleic acid, undecanoic acid, dodecanoic acid, tridecanoic acid, and combinations thereof; and
incorporating lithium into the liquid ink;
wherein the liquid ink includes:
a colorant;
an organic solvent package, including:
from about 1 wt % to about 12 wt %, with respect to the weight of the inkjet ink composition, of a first solvent having 1 or 2 free hydroxyl groups and 0 to 3 glycol units; and
from about 0.5 wt % to about 25 wt %, with respect to the weight of the inkjet ink composition, of a second solvent selected from the group consisting of 1-(2-hydroxyethyl)-2-pyrrolidinone, 2-pyrrolidone, glycerol, and combinations thereof; and
at least 50 wt % water with respect to the weight of the inkjet ink composition.

15. The method as defined in claim 14 wherein:
incorporating the acid involves adding from about 0.1 wt % to about 1.0 wt %, with respect to the total weight of the inkjet ink composition, of the acid into the liquid ink; and
incorporating the lithium involves adding from about 50 ppm to about 400 ppm of the lithium into the liquid ink.
